(19) United States
(12) Patent Application Publication
(10) Pub. No.: US 2015/0026367 A1
(43) Pub. Date: Jan. 22, 2015

(54) COMPUTER DEVICE AND IDENTIFICATION DEVICE THEREIN

(71) Applicant: Nuvoton Technology Corporation, Hsinchu (TW)

(72) Inventors: Shih-Hsuan YEN, Hsinchu (TW); Shih-Hao YEH, Hsinchu (TW)

(73) Assignee: Nuvoton Technology Corporation, Hsinchu (TW)

(21) Appl. No.: 14/275,902

(22) Filed: May 13, 2014

(30) Foreign Application Priority Data
Jul. 19, 2013 (TW) 102213709

(51) Int. Cl. G06F 11/30

(52) U.S. Cl. CPC G06F 11/3051
USPC 710/16

(57) ABSTRACT

An identification device includes a processing unit. The processing unit is electrically connected between a control circuit and a connection port, in which the processing unit is configured for detecting and identifying an external device which is connected to the port; when the processing unit identifies the external device as a first external device, the processing unit is configured for blocking information transmission between the first external device and the control circuit and when the processing unit identifies the external device as a second external device, the processing unit is configured for enabling the information transmission between the second external device and the control circuit.

### RELATED APPLICATIONS

This application claims priority to Taiwanese Application Serial Number 102213709, filed Jul. 19, 2013, which is herein incorporated by reference.

### BACKGROUND

1. Technical Field

The present disclosure relates to an identification device. More particularly, the present disclosure relates to an identification device configured for identifying external devices.

2. Description of Related Art

Because of the advancement of modern technology, external devices, for example, Universal Serial Bus (USB) devices (hereafter referred to as USB devices), are manufactured to be smaller, lighter, and easier to carry. If a USB device is carried into a company and the user connects it to a computer and copy the important data stored in the computer, it is possible that the data will be disclosed, resulting in an omission of information security of the company.

To avoid the aforementioned situation, in general, the methods used currently to block the USB device from copying the data in the computer are realized by software locks; that is, setting up an operation system of the computer, such that the operation system could protect the data in the computer from being obtained by others. However, this method could be broken by persons skilled in the art, such that persons with bad intention can still obtain the important data in the computer.

Therefore, it is necessary to provide a more reliable method to avoid the data in the computer, which needs to be protected, from being copied to the USB device, to achieve information security.

### SUMMARY

One aspect of the present disclosure is related to an identification device, which includes a processing unit. The processing unit is electrically connected between a control circuit and a connection port, in which the processing unit is configured for detecting and identifying an external device connected to the connection port. When the processing unit identifies the external device as a first external device, the processing unit is configured for blocking information transmission between the first external device and the control circuit; and when the processing unit identifies the external device as a second external device, the processing unit is configured for enabling information transmission between the second external device and the control circuit.

Another aspect of the present disclosure is related to a computer device, which includes a motherboard, a connection port, a control circuit, and a processing unit. The connection port is electrically connected to the motherboard. The control circuit is disposed on the motherboard. The processing unit is electrically connected to the motherboard and electrically connected between the control circuit and the connection port, wherein the processing unit is configured for detecting and identifying the external device connected to the connection port; when the processing unit identifies the external device as the first external device, the processing unit is configured for blocking the information transmission between the first external device and the control circuit; and when the processing unit identifies the external device as the second external device, the processing unit is configured for enabling the information transmission between the second external device and the control circuit.

One another aspect of the present disclosure is related to an identification method, which includes the following steps: detecting and identifying a USB device connected to a USB connection port; when the USB device is identified as a first USB device, blocking information transmission between the first USB device and a control circuit; and when the USB device is identified as a second USB device, enabling information transmission between the second USB device and the control circuit.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of an identification device in accordance with one embodiment of the present disclosure;

FIG. 2 is a schematic diagram of an identification device in accordance with another embodiment of the present disclosure;

FIG. 3 is a schematic diagram of an identification device in accordance with one another embodiment of the present disclosure;

FIG. 4 is a schematic diagram of an identification device in accordance with still another embodiment of the present disclosure;

FIG. 5 is a schematic diagram of a computer device in accordance with one embodiment of the present disclosure; and

FIG. 6 is a flow chart of an identification method in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

As used herein, “around”, “about”, “approximately” or “substantially” may generally mean within 20 percent, preferably within 10 percent, and more preferably within 5 percent of a given value or range, other within other percent of a given value or range. Numerical quantities given herein are approximate, meaning that the term “around”, “about”, “approximately” or “substantially” can be inferred if not expressly stated, or meaning other approximate values.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

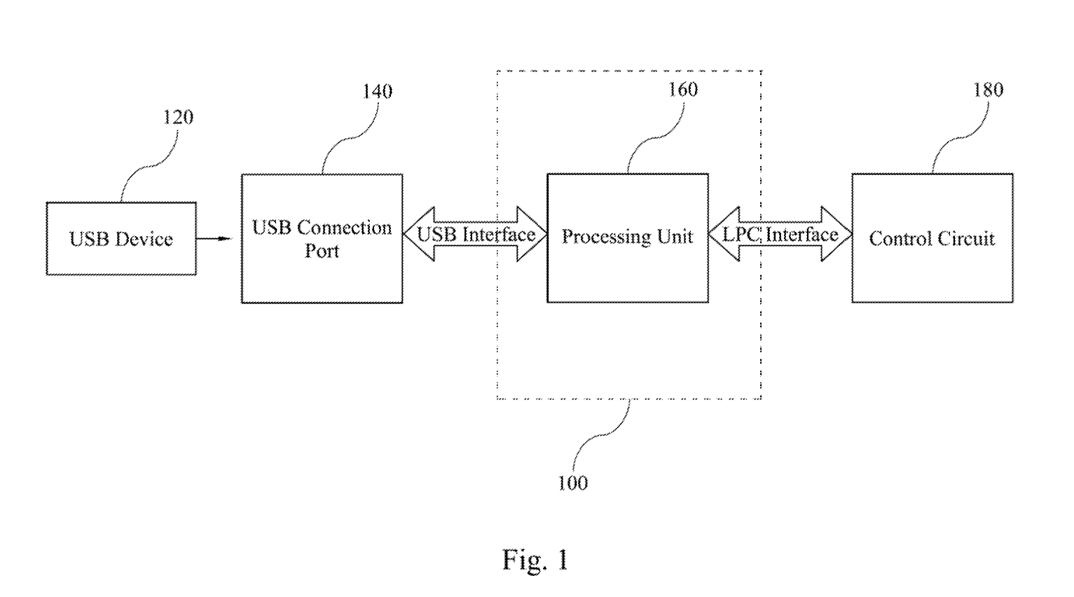

FIG. 1 is a schematic diagram of an identification device in accordance with one embodiment of the present disclosure. The identification device 100 includes a processing unit 160. The processing unit 160 is electrically connected between a control circuit 180 and a connection port (for example, a Universal Serial Bus connection port 140, hereafter referred to as USB connection port 140), wherein the processing unit 160 can be configured for detecting and identifying the external device (for example, a Universal Serial Bus (USB) device 120, hereafter referred to as USB device 120) connected to the connection port 140. In one embodiment, the control circuit 180 can be a chipset of a computer system, for example, a PCH (Platform Controller Hub) or a south bridge chip. As shown in FIG. 1, when an external device, for example, the USB device 120, is connected to the USB connection port 140, the processing unit 160 can identify the external device to determine that the external device is a first external device, for example, the first Universal Serial Bus device (hereafter be referred to as the first USB device), or a second external device, for example, the second Universal Serial Bus device (hereafter be referred to as the second USB device). If the processing unit 160 identifies the USB device 120 as the first USB device, the processing unit 160 can block the information transmission between the first USB device and the control circuit 180, such that the control circuit 180 can neither control the first USB device nor transmit information, for example, data or command, with the first USB device. If the processing unit 160 identifies the USB device 120 as the second USB device, the processing unit 160 enables the information transmission between the second USB device and the control circuit 180, such that the control circuit 180 can control the second USB device.

In practice, the processing unit 160 can be realized by integrated circuits, chips, or other configurations. Moreover, the external device mentioned above is not limited to a USB device, and it can be other common computer peripheral devices or components, and the connection port mentioned above is not limited to a USB connection port. The aforementioned and the following embodiments are given for illustration and not intended to be limiting of the present disclosure.

In an embodiment, when the processing unit 160 identifies the USB device 120 as a second USB device (for example, a mouse or a keyboard), the processing unit 160 can convert the first interface information (for example, USB interface information) outputted from the second USB device to a second interface information (for example, LPC interface information), and transmit the second interface information to the control circuit 180. Furthermore, the processing unit 160 can also convert the second interface information outputted from the control circuit 180 to first interface information, and transmit the first interface information to the second USB device, such that the control circuit 180 can communicate with the second USB device by the aforementioned conversion of interface information.

For example, if the first interface is a Universal Serial Bus (USB) interface, the second interface is a Low Pin Count (LPC) interface, and the first USB device is a flash disk, the second USB device is a mouse or a keyboard, then when the USB device 120 is connected to the USB connection port 140, the USB device 120 can output USB interface information. When the processing unit 160 identifies the USB device 120 as a mouse or keyboard through the USB interface information, the processing unit 160 converts the USB interface information to a LPC interface information, and outputs the LPC interface information to the control circuit 180 (for example, a south bridge chip or a PCH). At the moment, the control circuit 180 can transmit information with the mouse or the keyboard according to the LPC interface information, such that the mouse or the keyboard can be used by users. On the contrary, if the processing unit 160 identifies the USB device 120 as a flash disk through the USB interface information, the processing unit 160 stops converting the USB interface information to the LPC interface information. As a result, the control circuit 180 is unable to read the data in the flash disk, and the flash disk is neither able to access the data in the computer through the control circuit 180, such that the confidential data in the computer is prevented from being accessed by the flash disk arbitrarily, to achieve the purpose of data protection.

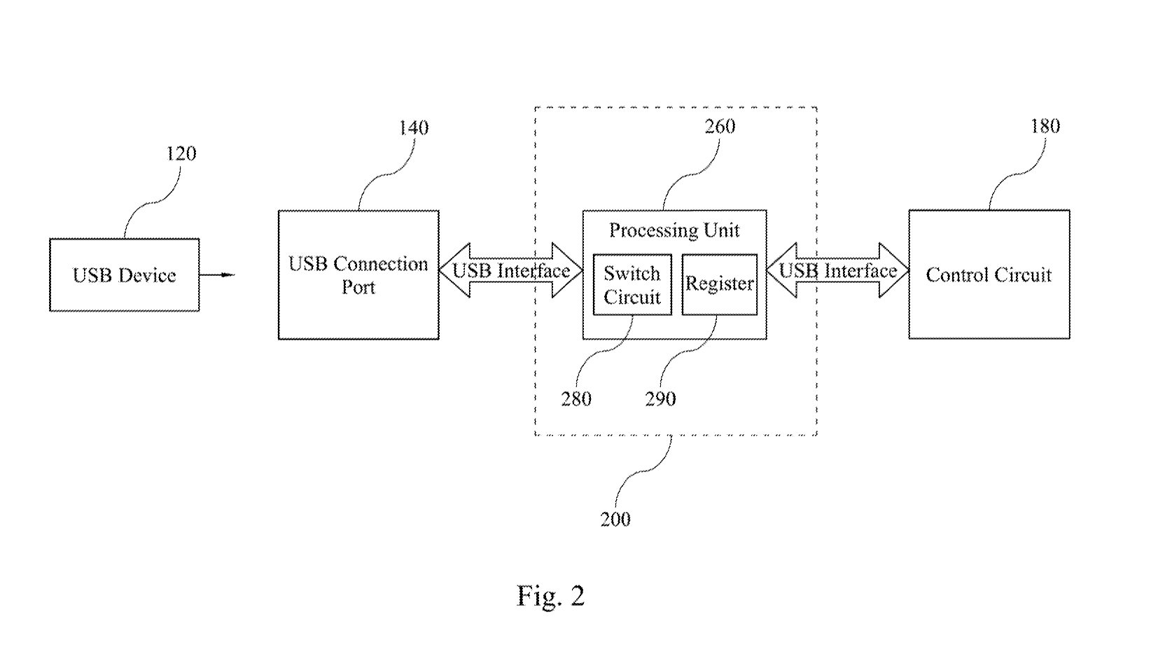

FIG. 2 is a schematic diagram of an identification device in accordance with another embodiment of the present disclosure. The identification device 200 includes a processing unit 260, and the processing unit 260 further includes a switch circuit 280. When the USB device 120 is connected to the USB connection port 140, the control circuit 180 (for example, a south bridge, a PCH, and so on) can initialize the USB device 120. The process of initialization, for example, let the USB device describe its relevant information, such as modes, interfaces or configurations, so that the processing unit is able to identify the USB device. When the processing unit 260 identifies the USB device 120 as a first USB device (for example, a flash disk), the switch circuit 280 interrupts the information transmission between the USB device 120 and the control circuit 180; and when the processing unit 260 identifies the USB device 120 as a second USB device (for example, a mouse or a keyboard), the switch circuit 280 keeps conducting the information transmission between the USB device 120 and the control circuit 180.

In an embodiment, the processing unit 260 can further include a determining unit (not depicted). The determining unit can be a controller, a processor, or other logical units, which is configured to determine that the USB device 120 is the first USB device or the second USB device, and to control the switch circuit 280 to switch off or on accordingly. It has to be explained that the aforementioned method of controlling the switch circuit 280 switching off and on is not limited thereto, and any hardware or software which can control the switching circuit 280 switching off or on is within the contemplated scope of the present disclosure.

In an embodiment, the processing unit 260 can further include a register 290. The register 290 can store a lookup table, in which the lookup table can be configured for recording and storing a plurality of data values corresponding to the USB device 120 (for example, a flash disk, a mouse, or a keyboard), for the processing unit 260 to identify the USB device 120 connected to the USB connection port 140 in accordance with the data values.

For example, in an application of a hub, when a plurality of USB devices 120 are connected to a plurality of USB connection ports 140 through the hub at the same time, every processing unit 260 can identify these USB devices 120 as flash disks, mouses, or keyboards according to the data values in the lookup table. Then, when the USB device 120 is identified as the flash disk, the switch circuit 280 can correspondingly interrupt the information transmission between the flash disk and the control circuit 180 (for example, a south bridge chip), such that the flash disk is not able to transmit information with the control circuit 180 through the processing unit 260; that is, the flash disk and the control circuit 180 are disconnected.

It has to be explained herein that in the embodiments of FIG. 1 and FIG. 2, whenever the users reconnect the USB device 120 to the USB connection port 140, the aforementioned operation of elements is restarted; that is, the identification device 100 of FIG. 1 and the identification device 200 of FIG. 2 will re-identify whether the USB device 120 is a first USB device or a second USB device.

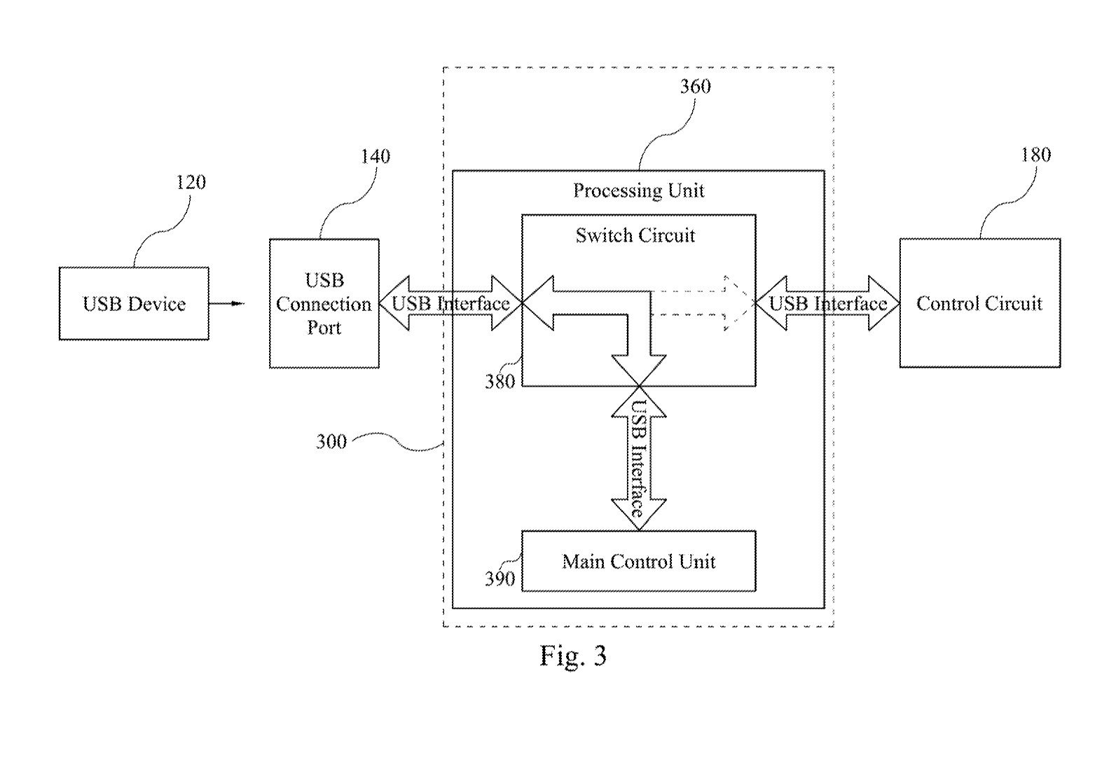

FIG. 3 is a schematic diagram of an identification device in accordance with another embodiment of the present disclosure, the identification device 300 includes the processing unit 360, and the processing unit 360 further includes the switch circuit 380 and the main control unit 390. The main control unit 390 can be configured for identifying the USB device 120 for controlling the switch circuit 380, wherein the switch circuit 380 is configured for conducting the USB connection port 140 and the control circuit 180, or configured for conducting the connection port 140 and the main control unit 390. When the main control unit 390 identifies the USB device 120 as a second USB device (for example, a mouse or a keyboard), the main control unit 390 controls the switch circuit 380, such that the switch circuit 380 conducts the second USB device and the control circuit 180.

In an embodiment, when the USB device 120 is connected to the USB connection port 140, the switch circuit 380 conducts the USB connection port 140 and the main control unit 390. The main control unit 390 can be provided with a firmware code, which can initialize the USB device 120 and identify the USB device 120.

For example, when the USB device 120 is identified as a flash disk, the main control unit 390 controls the switch circuit 380, such that the switch circuit 380 keeps conducting the information transmission between the flash disk and the main control unit 390 and stops the information transmission between the flash disk and the control circuit 180 (for example, a south bridge chip) and when the USB device 120 is identified as a mouse or a keyboard, the main control unit 390 controls the switch circuit 380, such that the switch circuit 380 conducts the information transmission between the mouse or the keyboard and the control circuit 180 and stops the information transmission between the mouse or the keyboard and the main control unit 390.

It has to be explained here that in practice, the main control unit 390 can be a controller or a micro controller. For example, the controller or the micro controller can be an embedded Super Input and Output chip (eSIO chip), an Embedded Controller (EC), or a Super Input and Output chip (SIO chip), but is not limited thereto, and any element with the functions mentioned above is covered by the present disclosure.

Moreover, the switch circuit 380 is further configured for detecting the connection status between the USB device 120 and the USB connection port 140. When the switch circuit 380 detects that the USB device 120 is not connected to the USB connection port 140, the switch circuit 380 can conduct the USB connection port 140 and the main control unit 390, and stop the information transmission between the USB device 120 and the control circuit 180. In other words, before the USB device 120 is reconnected to the USB connection port 140, the USB connection port 140 and the main control unit 390 are in a status in which the USB connection port 140 and the main control unit 390 transmit information with each other because of the conduction of the switch circuit 380.

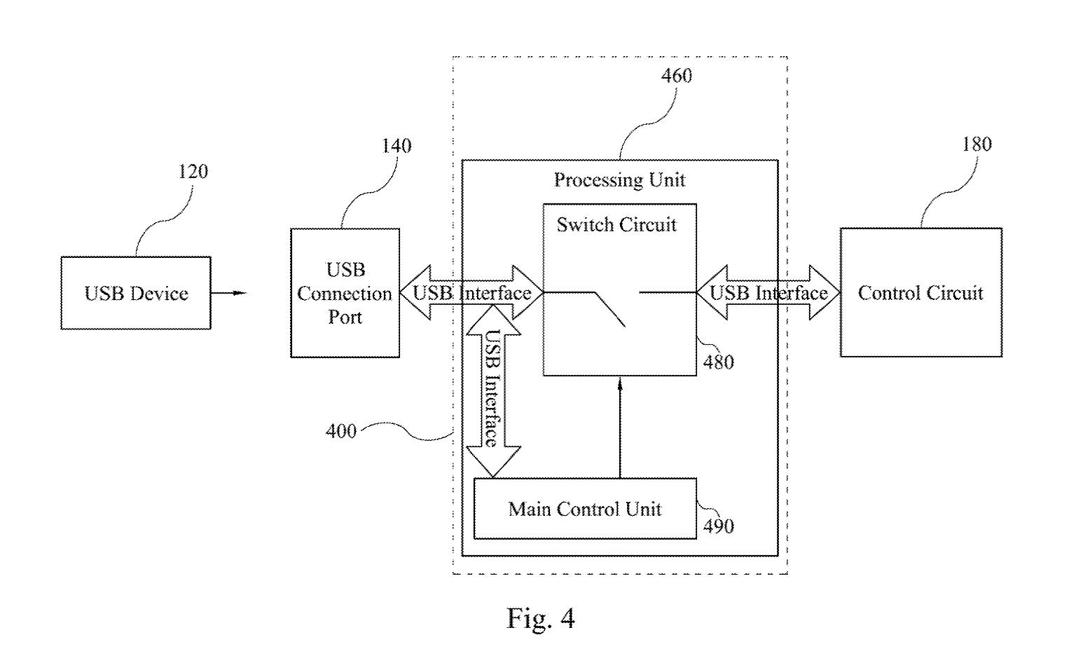

FIG. 4 is a schematic diagram of an identification device in accordance with another embodiment of the present disclosure, the identification device 400 includes the processing unit 460, and the processing unit 460 further includes the switch circuit 480 and the main control unit 490. The switch circuit 480 is configured for conducting the USB connection port 140 and the control circuit 180, and the main control unit 490 is configured for identifying and detecting the USB device 120.

The main control unit 490 can be kept conducted with the USB connection port 140 through the USB interface, and when the USB device 120 is connected to the USB connection port 140, the main control unit 490 initializes the USB device 120 to identify the USB device 120. The initial status of the switch circuit 480 is off, and if the main control unit 490 identifies the USB device 120 as the first USB device, the main control unit 490 does not control the switch circuit 480 to switch, such that the switch circuit 480 remains off, i.e., blocks the information transmission between the first USB device and the control circuit 180 (for example, a south bridge chip). On the contrary, if the main control unit 490 identifies the USB device 120 as the second USB device, the main control unit 490 controls the switch circuit 480 to switch, such that the switch circuit 480 conducts the second USB device and the control circuit 180. Moreover, when the second USB device is ejected and is not connected to the USB connection port 140, the main control unit 490 controls the switch circuit 480 switching back to the initial off status. The main control unit 490 will continue detecting and identifying the USB device 120, so as to perform the corresponding switches sequentially.

For example, if the main control unit 490 identifies the USB device 120 as a flash disk, the main control unit does not switch the switch circuit 480 such that the switch circuit 480 remains off, i.e., blocking the information transmission between the flash disk and the control circuit 180 (for example, a south bridge chip). And if the main control unit 490 identifies the USB device 120 as a mouse or a keyboard, the main control unit 490 controls the switch circuit 480 to switch, such that the switch circuit 480 conducts the information transmission between the mouse or the keyboard and the control circuit 180. Moreover, when the mouse or the keyboard is ejected and is not connected to the USB connection port 140, the main control unit 490 controls the switch circuit 480 switching back to the initial off status. The main control unit 490 will continue detecting and identifying the USB device 120, so as to perform the corresponding switches sequentially.

It should be noticed here that in the embodiment of FIG. 4, the USB connection port 140 keeps the conduction status with the main control unit 490, no matter when the main control unit 490 identifies the USB device 120 as a first USB device or a second USB device. That is, if the USB device 120 is identified as a second USB device, the USB connection port 140 is conducted with the control circuit 180 through the switch circuit 480, and also conducts the main control unit 490. At the moment, the USB interface of the main control unit 490 is set to be a tri-state; that is, the main control unit 490 can keep detecting the information and the status of the USB interface but does not take control of it.

The above description of the embodiment in FIG. 4 is different from the embodiment depicted in FIG. 3. In the embodiment of FIG. 3, if the USB device 120 is identified to be a first USB device, the USB connection port 140 will be in a conduction status with the main control unit 390, and if the USB device 120 is identified to be a second USB device, the USB connection port 140 will be conducted with the control circuit 180 and disconnected from the main control unit 390.

Moreover, in FIG. 4, the main control unit 490 is further configured for detecting the connection status between the USB device 120 and the USB connection port 140. When the USB device 120 is not connected to the USB connection port 140, the main control unit 490 controls the switch circuit 480 such that the switch circuit 480 interrupts the information transmission with the control circuit 180. Until the USB device 120 is reconnected to the USB connection port 140, the main control unit 490 re-identifies whether the USB device 120 is a first USB device or a second USB device.

In some embodiments, the processing unit 360 in FIG. 3 mentioned above or the processing unit 460 in FIG. 4 mentioned above can also include the register 290 in FIG. 2, which is configured for recording and storing the data corresponding to the USB device 120, for the sequential identification process.

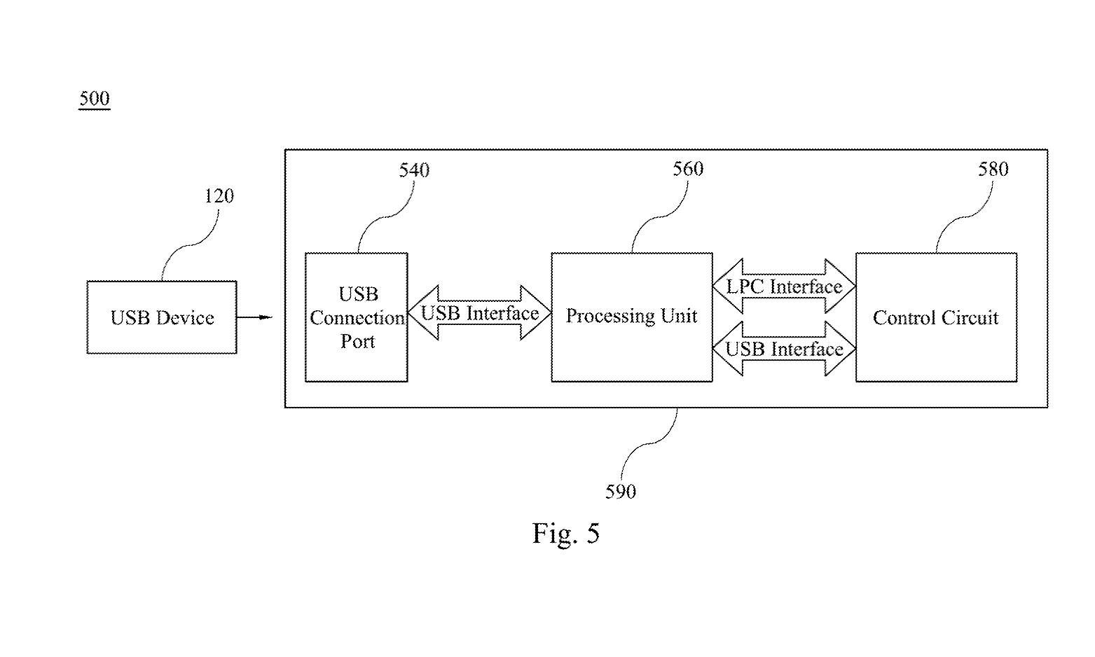

FIG. 5 is a schematic diagram of a computer device in accordance with an embodiment of the present disclosure. The computer device 500 includes a motherboard 590, a USB connection port 540, a processing unit 560, and a control circuit 580. The USB connection port 540, the processing unit 560, and the control circuit 580 are disposed on the motherboard 590, or are electrically connected to the motherboard 590. The connection and operation relation of the USB connection port 540, the processing unit 560, and the control circuit 580 are similar to the USB connection port 140, the processing unit 160, and the control circuit 180 mentioned above, and therefore they are not further detailed herein. Similarly, when the USB device 120 is connected to the USB connection port 540, the processing unit 560 can perform the identification operation in FIG. 1 mentioned above such that the USB device 120 is identified as a first USB device or a second USB device. Moreover, the processing unit 560, as mentioned above, can be replaced as the processing unit 260 in FIG. 2, the processing unit 360 in FIG. 3, or the processing unit 460 in FIG. 4, and can perform the identification operation in FIG. 2, FIG. 3, or FIG. 4 mentioned above.

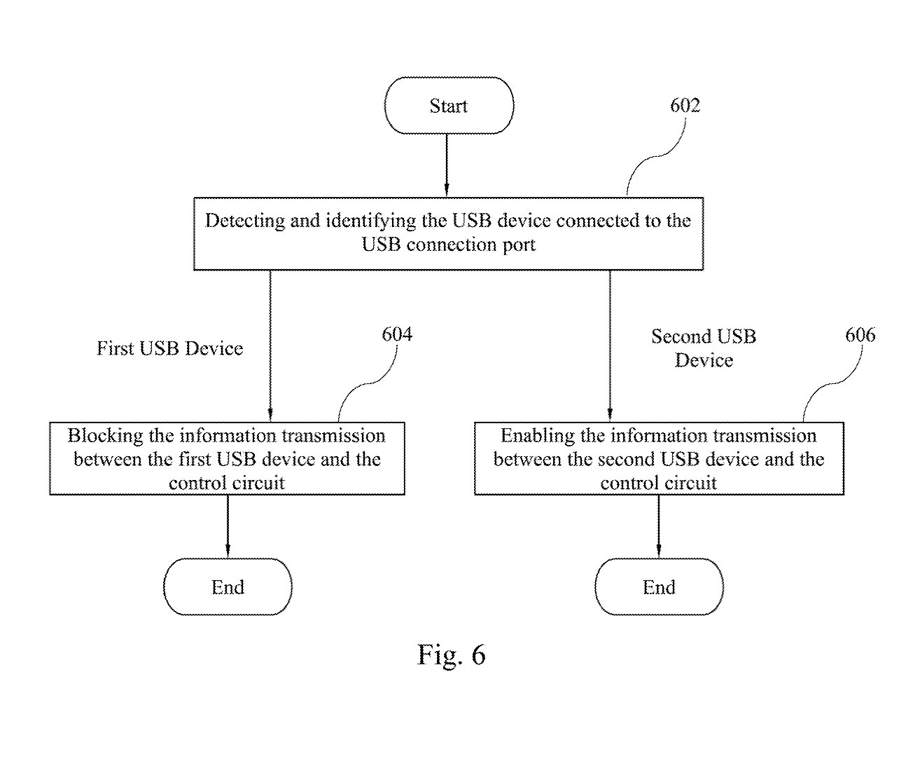

FIG. 6 is a flow chart of an identification method in accordance with an embodiment of the present disclosure. For convenience of illustration, reference to FIG. 1 and FIG. 6 are made at the same time. The aforementioned method includes the following steps. In step 602, the USB device 120 (see FIG. 1) connected to the USB connection port 140 (see FIG. 1) is detected and identified. When the USB device 120 is identified as a first USB device, step 604 is performed to block the information transmission between the first USB device and the control circuit 180 (see FIG. 1). When the USB device 120 is identified as a second USB device, perform step 606, to enable the information transmission between the second USB device and the control circuit 180.

It should be noticed here that the first USB device can be a flash disk, the second USB device can be a mouse or a keyboard, and the control circuit 180 can be a south bridge chip, but is not limited herein. As mentioned in step 602, after the USB device 120 is identified as the first USB device or the second USB device, the information transmission between the USB device 120 and the control circuit 180 could be blocked or enabled.

In step 602, the step of detecting and identifying the USB device 120 connected to the USB connection port 140 further includes the following steps. When the USB device 120 is identified as the first USB device, interrupt the information transmission between the USB device 120 and the control circuit 180; and when the USB device 120 is identified as a second USB device, enable the information transmission between the USB device 120 and the control circuit 180. That is, when the USB device 120 is identified as a first USB device, the first USB device can not transmit information with the control circuit 180. At this time, the users can neither read the data in the USB device 120 nor download the data from the computer to the USB device 120 through the control circuit 180; but if the USB device 120 is identified as a second USB device, the second USB device can transmit information with the control circuit 180, and the users can read the data in the USB device 120 or read the data transmitted through the USB device 120, and use the USB device 120.

Step 602 also includes the following steps. When the USB device 120 is detected not connected to the USB connection port 140, control a switch circuit (the switch circuit can be the switch circuit 280 in FIG. 2, the switch circuit 380 in FIG. 3, or the switch circuit 480 in FIG. 4), such that the switch circuit mentioned above interrupts the information transmission with the control circuit 180. In other words, when the USB device 120 is detected not connected to the USB connection port 140, the USB connection port 140 can stop the information transmission with the control circuit 180 by the off switch circuit.

In step 606, the step of enabling the information transmission between the second USB device and the control circuit 180 further includes: converting the first interface information outputted from the second USB device (for example, a USB interface information) to a second interface information (for example, a LPC interface information), and transmit the second interface information to the control circuit 180. Moreover, it can also convert the second interface information (for example, a LPC interface information) to a first interface information (for example, a USB interface information), and transmit the first interface information to the second USB device, such that the control circuit 180 can control the second USB device, or communicate with the second USB device. At the moment, the control circuit 180 controls the second USB device according to the second interface information (for example, a LPC interface information), instead of controlling the second USB device directly according to the first interface information (for example, a USB interface information).

Moreover, step 606 also includes: controlling a switch circuit (the switch circuit can be the switch circuit 280 in FIG. 2, the switch circuit 380 in FIG. 3, or the switch circuit 480 in FIG. 4), such that the switch circuit conducts the second USB device and the control circuit 180, and enables the information transmission between the second USB device and the control circuit 180. That is, when enabling the information transmission between the second USB device and the control circuit 180, the switch circuit mentioned above can conduct the second USB device and the control circuit 180 for them to communicate.

In an embodiment, step 602 can be performed to identify whether the USB device 120 connected to the USB connection port 140 is a mouse or a keyboard (i.e., the second USB device in FIG. 6). If so, it can access the information inside a mouse or a keyboard by converting the USB interface information to LPC interface information (i.e., performing step 606). On the contrary, if the USB device 120 is identified as neither a mouse nor a keyboard, stop accessing the USB device 120 until the USB device 120 is reconnected to the USB connection port 140 (i.e., performing step 604).

In another embodiment, when step 602 identifies the USB device 120 as a mouse or a keyboard, step 606 is performed to keep the information transmission between the control circuit 180 and the USB device 120; on the contrary, when step 602 identifies the USB device 120 neither a mouse nor a keyboard, perform step 604 to interrupt the information transmission between the control circuit 180 and the USB device 120.

For convenience of illustration, please refer to FIG. 3 and FIG. 6 simultaneously. In one another embodiment, the USB device 120 connected to the USB connection port 140 is identified whether it is a keyboard or a mouse by the main control unit 390 through the first interface (for example, the USB interface) (step 602). If so, the main control unit 390 controls the switch circuit 380 such that the switch circuit 380 conducts the information transmission between the mouse or the keyboard and the control circuit 180 for the mouse or the keyboard to function normally (step 606). On the contrary, if the USB device 120 is identified neither a mouse nor a keyboard, the control unit 390 stops switching the switch circuit 380 such that the switch circuit 380 is in a conduction status with the main control unit 390, and in a disconnection status with the control circuit 180 (step 604).

Please refer to FIG. 4 and FIG. 6 simultaneously. In one another embodiment, the USB device 120 connected to the USB connection port 140 is identified whether it is a keyboard or a mouse by the main control unit 490 through the first interface (for example, the USB interface) (step 602). If so, the main control unit 490 controls the switch circuit 480 such that the switch circuit 480 conducts the information transmission between the mouse or the keyboard and the control circuit 180 (step 606).

At this time, the main control unit 490 merely detects the status of the USB interface to determine whether the USB device 120 is re-plugged. If so, the main control unit 490 controls the switch circuit 480 to interrupt the information transmission between the USB device 120 and the control circuit 180, return back to step 602 again to identify the USB device 120. If no, the main control unit 490 keeps detecting the status of the USB interface.

On the contrary, in step 602, if the USB device 120 is identified neither a mouse nor a keyboard, perform step 604 to stop switching the switch circuit 480 through the main control unit 490, such that the switch circuit 480 is in a disconnection status with the control circuit 180.

To sum up, the embodiments of the disclosure discloses an identification device, which can identify the external device (for example, a USB device) connected to the connection port (for example, a USB connection port). If the external device is identified as a first external device (for example, a first USB device), the users can't use the first external device. On the contrary, if the external device is identified as a second external device (for example, a second USB device), the users can use the second external device. In this way, if the USB device is identified as a first USB device (for example, a flash disk), the first USB device can not access the data in the computer, such that the confidential data in the computer can not be accessed arbitrarily, to achieve the purpose of data protection. Moreover, when different USB devices are connected to the USB connection port at the same time, the identification device can identify that each of the USB devices is the first USB device or the second USB device.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An identification device, comprising:
a processing unit electrically connected between a control circuit and a connection port, wherein the processing unit is configured for detecting and identifying an external device connected to the connection port;
wherein when the processing unit identifies the external device as a first external device, the processing unit is configured for blocking information transmission between the first external device and the control circuit; and
wherein when the processing unit identifies the external device as a second external device, the processing unit is configured for enabling information transmission between the second external device and the control circuit.

2. The identification device of claim 1, wherein
when the processing unit identifies the external device as the second external device, the processing unit is further configured for converting first interface information outputted from the second external device to second interface information, and configured for outputting the second interface information to the control circuit; and
the processing unit is further configured for converting the second interface information outputted from the control circuit to the first interface information, and configured for outputting the first interface information to the second external device, such that the control circuit communicates with the second external device.

3. The identification device of claim 1, wherein the processing unit comprises:
a switch circuit; and
when the processing unit identifies the external device as the first external device, the switch circuit interrupts the information transmission between the external device and the control circuit; and when the processing unit identifies the external device as the second external device, the switch circuit keeps conducting the information transmission between the external device and the control circuit.

4. The identification device of claim 1, wherein the processing unit comprises:
a register, which is configured for storing a lookup table, wherein the lookup table is configured for recording and storing a plurality of data values corresponding to the first external device and the second external device, for the processing unit to identify the external device connected to the connection port in accordance with the data values.

5. The identification device of claim 1, wherein the processing unit comprises:
a switch circuit; and
a main control unit, which is configured for identifying the external device for controlling the switch circuit, wherein the switch circuit is configured for conducting the connection port and the control circuit, or configured for conducting the connection port and the main control unit;
wherein when the main control unit identifies the external device as the second external device, the main control unit controls the switch circuit, such that the switch circuit conducts the external device and the control circuit.

6. The identification device of claim 5, wherein the switch circuit is further configured for detecting a connection status between the external device and the connection port, wherein when the external device is not connected to the connection port, the switch circuit is configured for conducting the connection port and the main control unit.

7. The identification device of claim 1, wherein the processing unit comprises:
a switch circuit, which is configured for conducting the connection port and the control circuit; and
a main control unit, which is configured for identifying the external device;
wherein when the main control unit identifies the external device as the second external device, the main control unit switches the switch circuit, such that the switch circuit conducts the second external device and the control circuit.

8. The identification device of claim 7, wherein the main control unit is further configured for detecting the connection status between the external device and the connection port, wherein when the external device is not connected to the connection port, the main control unit controls the switch circuit, such that the switch circuit disconnects the connection between the connection port and the control circuit.

9. The identification device of claim 1, wherein the connection port is a Universal Serial Bus (USB) connection port, and the external device is a USB device, and when the USB device is a first USB device, the processing unit is configured for blocking the first USB device from accessing data from a host through the control circuit.

10. A computer device, comprising:
a motherboard;
a connection port, electrically connected to the motherboard;
a control circuit, disposed on the motherboard; and
a processing unit, electrically connected to the motherboard and electrically connected between the control circuit and the connection port, wherein the processing unit is configured for detecting and identifying the external device connected to the connection port;
when the processing unit identifies the external device as the first external device, the processing unit is configured for blocking the information transmission between the first external device and the control circuit; and
when the processing unit identifies the external device as the second external device, the processing unit is configured for enabling the information transmission between the second external device and the control circuit.

11. The computer device of claim 10, wherein
when the processing unit identifies the external device as the second external device, the processing unit is further configured for converting first interface information outputted from the second external device to second interface information, and configured for outputting the second interface information to the control circuit; and
the processing unit is further configured for converting the second interface information outputted from the control circuit to the first interface information, and configured for outputting the first interface information to the second external device, such that the control circuit communicates with the second external device.

12. The computer device of claim 10, wherein the processing unit comprises:
a switch circuit; and
when the processing unit identifies the external device as the first external device, the switch circuit interrupts the information transmission between the external device and the control circuit; and when the processing unit identifies the external device as the second external device, the switch circuit keeps conducting the information transmission between the external device and the control circuit.

13. The computer device of claim 10, wherein the processing unit comprises:
a register, which is configured for storing a lookup table, wherein the lookup table is configured for recording and storing a plurality of data values corresponding to the first external device and the second external device, for the processing unit to identify the external device connected to the connection port in accordance with the data values.

14. The computer device of claim 10, wherein the processing unit comprises:
a switch circuit; and
a main control unit, which is configured for identifying the external device for controlling the switch circuit, wherein the switch circuit is configured for conducting the connection port and the control circuit, or configured for conducting the connection port and the main control unit;
wherein when the main control unit identifies the external device as the second external device, the main control unit controls the switch circuit, such that the switch circuit conducts the external device and the control circuit.

15. The computer device of claim 14, wherein the switch circuit is further configured for detecting a connection status between the external device and the connection port, wherein when the external device is not connected to the connection port, the switch circuit is configured for conducting the connection port and the main control unit.

16. The computer device of claim 10, wherein the processing unit comprises:
a switch circuit, which is configured for conducting the connection port and the control circuit; and
a main control unit, which is configured for identifying the external device;
wherein when the main control unit identifies the external device as the second external device, the main control unit switches the switch circuit, such that the switch circuit conducts the second external device and the control circuit.

17. The computer device of claim 16, wherein the main control unit is further configured for detecting the connection status between the external device and the connection port, wherein when the external device is not connected to the connection port, the main control unit controls the switch circuit, such that the switch circuit disconnects the connection between the connection port and the control circuit.

18. An identification method, comprising:
detecting and identifying a USB device connected to a USB connection port;
when the USB device is identified as a first USB device, blocking information transmission between the first USB device and a control circuit; and
when the USB device is identified as a second USB device, enabling information transmission between the second USB device and the control circuit.

19. The identification method of claim 18, wherein enabling the information transmission between the second USB device and the control circuit further comprises:
converting a first interface information outputted from the second USB device to a second interface information, and output the second interface information to the control circuit; and
converting the second interface information outputted from the control circuit to the first interface information, and output the first interface information to the second USB device, such that the control circuit communicates with the second USB device.

20. The identification method of claim 18, wherein enabling the information transmission between the second USB device and the control circuit further comprise:
controlling a switch circuit, such that the switch circuit conducts the second USB device and the control circuit.

21. The identification method of claim 18, wherein detecting and identifying the USB device connected to the USB connection port further comprises:
when the USB device is detected not being connected to the USB connection port, control a switch circuit, such that the switch circuit disconnects the connection between the USB connection port and the control circuit.
